(19) United States
(12) Patent Application Publication
(10) Pub. No.: US 2019/0001475 A1
(43) Pub. Date: Jan. 3, 2019

(54) Stapler for a Fence Post

(71) Applicant: Jeffrey S. Vitek, Rayland, OH (US)

(72) Inventor: Jeffrey S. Vitek, Rayland, OH (US)

(21) Appl. No.: 15/783,329

(22) Filed: Oct. 13, 2017

Related U.S. Application Data
(60) Provisional application No. 62/527,112, filed on Jun. 30, 2017.

(51) Int. Cl. B25C 5/11; B25C 7/00; E04H 17/26

(52) U.S. Cl. CPC B25C 5/11; E04H 17/268; B25C 7/00

(57) ABSTRACT

A stapler for a fence post incorporates a tubular sleeve configured to hold a single staple, in a first sleeve end and a bolt configured to be inserted into a second sleeve end and to moveably rest within the interior space of the sleeve. When inserted into the sleeve, a first end of the bolt is in contact with the staple head positioned within the first sleeve end. An impact surface is secured to a second bolt end and remains outside of the sleeve. A wingnut is secured through an aperture within the sleeve adjacent the second sleeve end. The distal end of the wingnut selectively engages a notch cut into the surface of the bolt adjacent the impact surface and having a length which generally corresponds to that of a staple. The device is configured to transfer a force from the impact surface to the staple head thereby driving the staple into a surface such as that of a fence post.

### RELATED APPLICATIONS

The present invention was first described in and claims the benefit of U.S. Provisional Application No. 62/527,112, filed Jun. 30, 2017, the entire disclosures of which are incorporated herein by reference.

### FIELD OF THE INVENTION

The present invention relates generally to the field of a fastener delivery device particularly suited for use in installing and erecting fences.

### BACKGROUND OF THE INVENTION

Domesticated animals on farms and ranches across the country have been contained by wire fences for years. This type of fencing, supplied in rolls, is attached to upright wood posts using large staples or nails. This fencing is relatively cheap, easy to install, and works fairly effectively in containing animals such as horses, cattle, sheep, goats, and the like. It can also be used in conjunction with barb-wire, especially on the top rail, to further enhance its protective characteristics. The staples used to hold such fencing or wires are simple “U” shapes that are pounded in with a hammer

Herein lies two (2) disadvantages. First, the staples must be held by fingers of one (1) hand while the other is used to hold a hammer to pound them in. Even the most careful user will frequently smash their fingers in this process. Second, the staples are often driven in too far where they may actually cut the fence or wire or severely crimp it leading to premature failure at a later time. These same problems are often present when stapling other linear items such as wire, cable, tubing or the like. Accordingly, there is a need for a means by which single “U”-shaped staples can be driven in to contain and secure linear materials such as fencing, wire, cable, tubing, and the like in an effort to address the above-mentioned deficiencies. The development of the staple holder and installation aid device fulfills this need.

### SUMMARY OF THE INVENTION

The inventor has recognized the aforementioned issues and inherent problems and observed that there is a lack in the prior art for a fastener delivery device particularly suited for use in installing and erecting fences.

It is therefore an object of the invention to provide a staple installation tool comprising an outer tube which itself comprises an outer tube first end, an outer tube second end, an inner void running from the outer tube first end to the outer tube second end, a flared portion disposed at the outer tube first end, a threaded portion disposed at the outer tube second end, an aperture disposed upon an exterior surface of the outer tube and a fastener configured to secure within the aperture. The flared portion defines an interior configured to removeably secure a staple. A separate embodiment also comprises an “O”-ring which is secured about the threaded outer surface adjacent the depth adjustment nut opposite the domed top.

The staple installation tool also comprises an inner plunger which has a threaded outer surface itself comprising an inner plunger first end, an inner plunger second end, a domed top secured to the inner plunger second end and a depth adjustment nut configured to threadingly engage the threaded outer surface adjacent the domed top. A diameter of the inner void is greater than a diameter of the inner plunger and when the inner plunger is inserted into the outer tube second end having the staple removeably inserted into the flared portion, a first force applied to the domed top is transferred through the inner plunger into a head of the staple thereby driving the point sides of the staple into a surface.

The plunger further comprises a first flattened area disposed at the inner plunger first end and a second flattened area disposed adjacent the inner plunger second end. The first flattened region is configured to engage the head of the staple. The second flattened region is configured to selectively engage a distal end of the fastener. When inserted into the aperture, the distal end of the fastener limits a range of movement of the plunger within the outer tube.

The fastener may comprise a wing bolt. The depth adjustment nut may be greater than an outer diameter of the outer tube. The outer tube may comprise a length of no more than seven and one-half inches (7-½ in.). The inner void may comprise a diameter of no more than one-half an inch (½ in.), the flared portion may comprise a length of no more than one and one-half inches (1-½ in.) and the flared portion may comprises an outer width of no more than seven-eighths of an inch (⅞ in.). The flared portion comprises an inner width of no more than eleven sixteenths of an inch ( 11/16 in.). While a cap is configured to threadingly secure about the outer tube second end.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of the of the staple holder and installation aid device 10, according to the preferred embodiment of the present invention;

FIG. 2 is an isometric view of the outer tube 15, as used with the staple holder and installation aid device 10, according to the preferred embodiment of the present invention;

FIG. 3 is an isometric view of the inner plunger 20, as used with the staple holder and installation aid device 10, according to the preferred embodiment of the present invention; and,

FIG. 4 is a perspective view of the staple holder and installation aid device 10, shown in a utilized state, according to the preferred embodiment of the present invention.

### DESCRIPTIVE KEY

10 staple holder and installation aid device

15 outer tube

17 inner cylindrical void

20 inner plunger

25 flared portion

30 staple

35 connecting fastener

40 threaded opening

45 domed top

50 threaded outer surface

55 depth adjustment nut

60 rubber “O” ring

65 threaded outer tube surface

70 first flattened area

75 second flattened area

80 user

85 first hand

90 second hand

95 pounding tool

100 linear element

105 attachment surface

### DETAILED DESCRIPTION OF THE PREFERRED EMBODIMENT

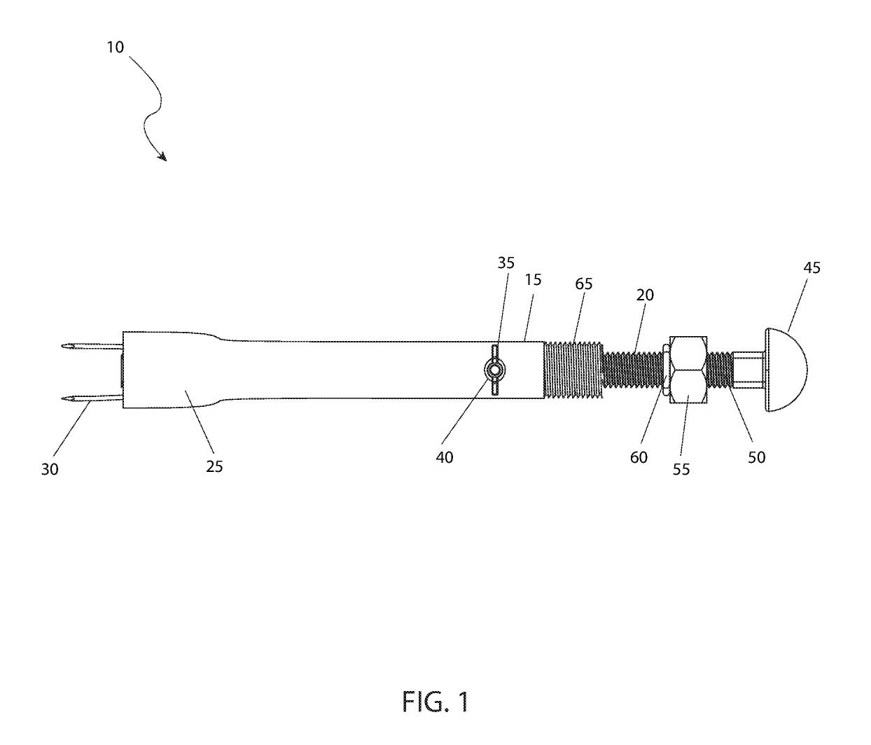

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope.

The terms “a” and “an” herein do not denote a limitation of quantity, but rather denote the presence of at least one (1) of the referenced items.

Referring now to FIG. 1, an isometric view of the staple holder and installation aid device 10, according to the preferred embodiment of the present invention, is disclosed. The staple holder and installation aid device 10 (herein also described as the “device”) 10, includes of two (2) major components, an outer tube 15 and an inner plunger 20, with the latter fitting inside the former. The outer tube 15 is tubular in nature for the majority of its length, with a flared portion 25 at its distal end having an inner cylindrical void 17. The flared portion 25 is used to secure a staple 30 by friction fit. The staple 30 can be any type of a wide variety of single staples including but not limited to fencing staples (as depicted), wire staples, mesh staples, cable (Romex®) staples, tubing staples or the like. It is envisioned that the flared portion 25 would be unique for each various type of staple 30. The inclusion or exclusion of any particular type of staple 30 is not intended to be a limiting factor of the present invention.

The outer tube 15 is provided with a connecting fastener 35, such as a wing bolt, at its proximal end. The connecting fastener 35 is fastened to a threaded opening 40 in the outer tube 15 and will be described in greater detail herein below. The connecting fastener 35, when tightened, impinges upon the upper and lower shoulders of the second flattened area 70 on the inner plunger 20 and secures them together for purposes of transport to prevent inadvertent separation. The inner plunger 20 is provided with a domed top 45 which serves as an impact surface for pounding the staple 30 into an attaching surface. The inner plunger 20 is provided with a threaded outer surface 50 which accepts a depth adjustment nut 55. Located immediately below the depth adjustment nut 55 is a rubber “O” ring 60. The rubber “O” ring 60 serves as a visual stopping point to alert the user when the depth adjustment nut 55 impacts the outer tube 15. The rubber “O” ring 60 also physically impinges on the depth adjustment nut 55 and prevents unwanted movement during usage of the device 10.

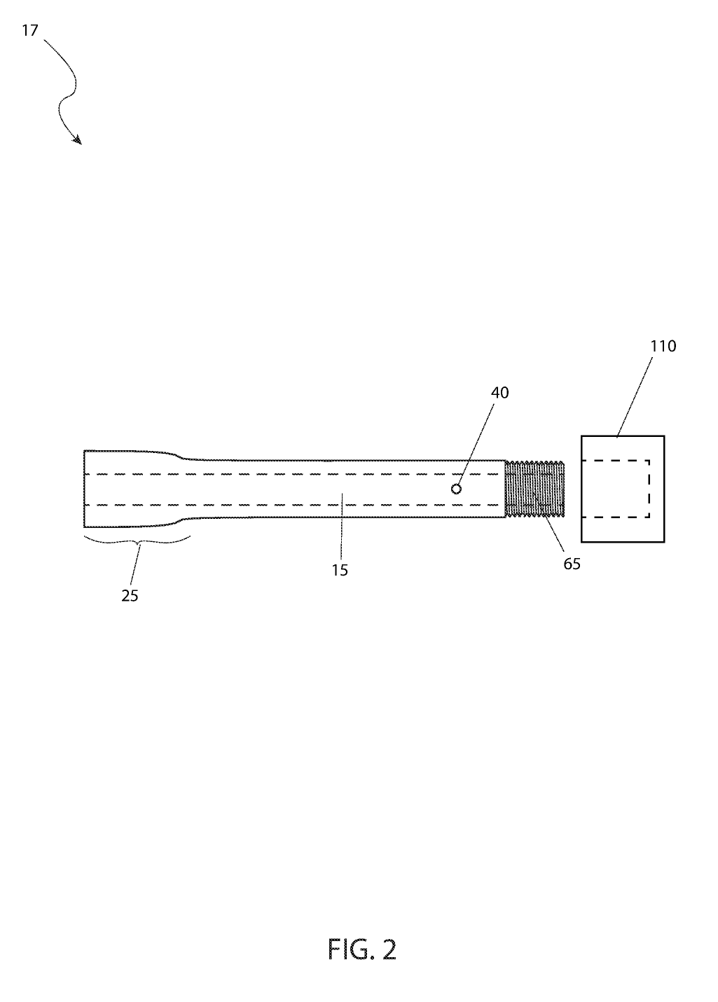

Referring next to FIG. 2, an isometric view of the outer tube 15, as used with the device 10, according to the preferred embodiment of the present invention is depicted. The outer tube 15 is approximately seven and one-half inches (7-½ in.) in length and one-half inch (½ in.) inner diameter herein depicted by dashed lines. The flared portion 25 is approximately one-and-a-half (1-½ in.) inches in length with an outer width of seven-eighths of an inch (⅞ in.) and an inner width of eleven sixteenths of an inch ( 11/16 in.). The threaded opening 40 is provided with a threaded surface of sixty-seven hundredths of an inch (0.670 in.) which accepts the connecting fastener 35 (as shown in FIG. 1) Finally, the outer tube 15 is provided with a threaded outer tube surface 65 which accepts a cap 110. It is envisioned that the inner plunger 20 (as shown in FIG. 1) is never completely removed or separated from the outer tube 15 during normal use, the cap 110 is likely never placed or utilized.

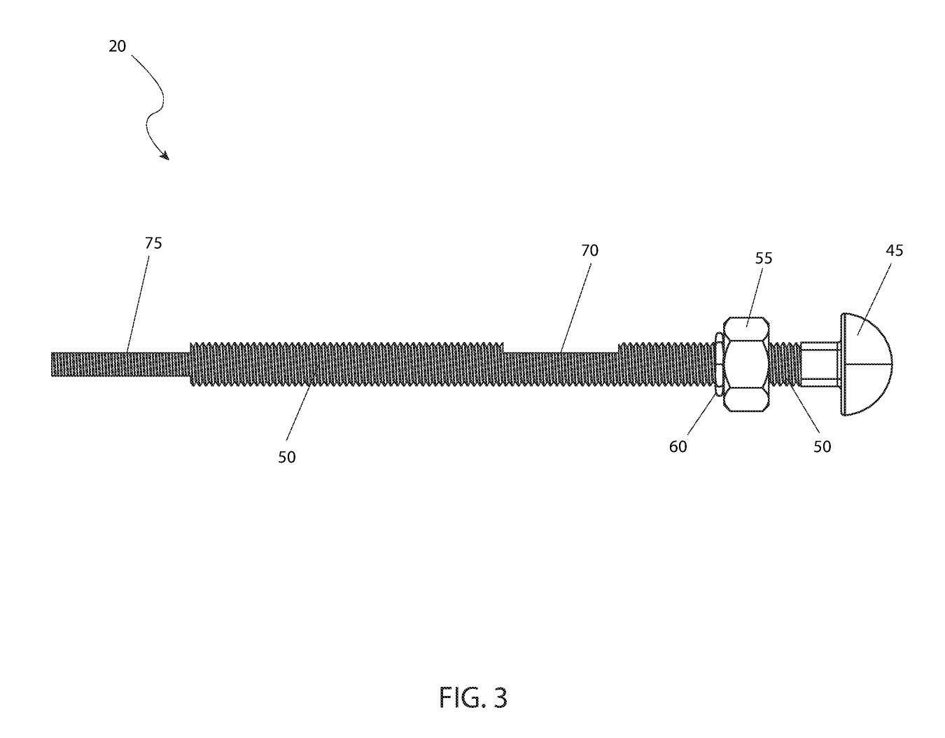

Referring now to FIG. 3, an isometric view of the inner plunger 20, as used with the device 10, according to the preferred embodiment of the present invention is shown. The overall length of the inner plunger 20 is eight inches (8 in.) and is one-half inch (½ in.) in diameter. The threaded outer surface 50 extends for the entire length of the inner plunger 20 which is cylindrical in nature with the exception of two (2) areas. A first flattened area 70 is located at the proximal end of the inner plunger 20 and aligns with the threaded opening 40 (as shown in FIG. 2). The first flattened area 70 serves as an area for which the connecting fastener 35 (as shown in FIG. 1) may contact when tightened for storage and transport. A second flattened area 75 is provided at the distal end of the inner plunger 20 and provides for a thinner profile which may fit within the flared portion 25 (as shown in FIG. 2) of the outer tube 15 (as shown in FIG. 2). The domed top 45, the depth adjustment nut 55 and the rubber “O” ring 60 are visible as well. The depth adjustment nut 55 allow the user to control the penetration depth of the staple 30 (as shown in FIG. 1) to prevent crimping the material being fastened such as fencing, mesh, cable, tubing, or the like. As such, the depth adjustment nut 55 in conjunction with the rubber “O” ring 60 provides for consistent and calibrated penetration to serve as a visual stopping point during the pounding process and serves as a physical barrier to prevent over penetration or crimping.

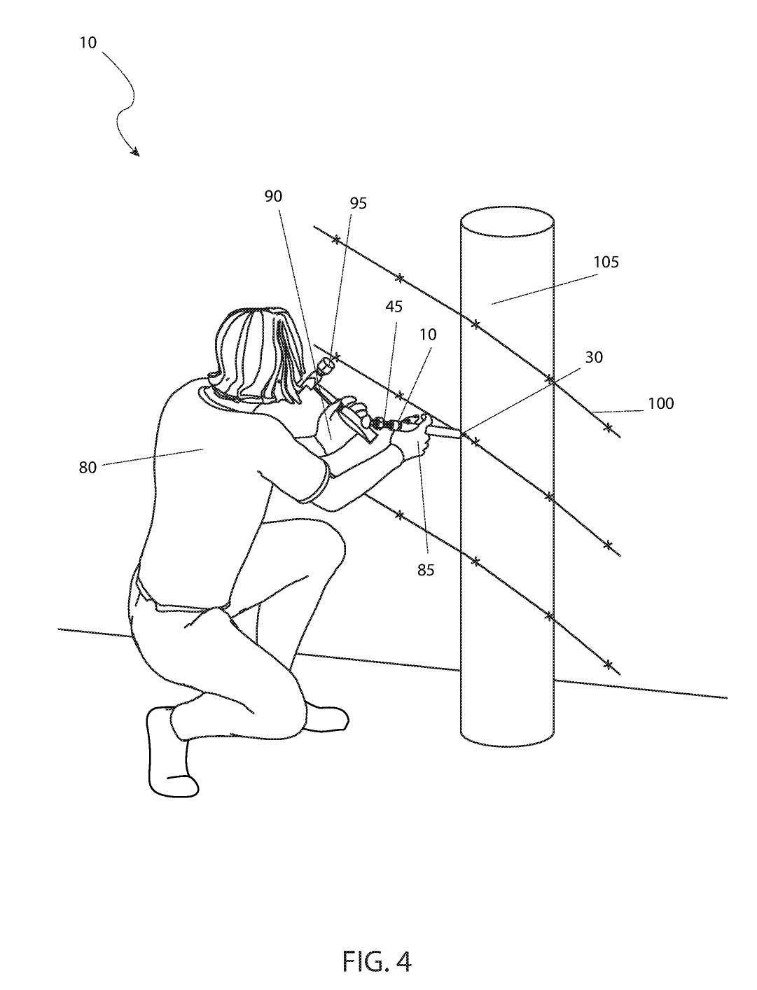

Referring finally to FIG. 4, a perspective view of the device 10, shown in a utilized state, according to the preferred embodiment of the present invention is disclosed. A user 80 grasps the device 10 in a firsthand 85 while using the second hand 90 to hold a pounding tool 95 such as a hammer A staple 30 is positioned in the device 10 and is centered over a linear element 100, depicted here as barbed wire for illustrative purposes only. The staple 30 is then fastened to an attachment surface 105, depicted herein as a wooden fence post for illustrative purposes only. By repeated hammer blows upon the domed top 45 of the device 10, the staple 30 is driven to a satisfactory depth into the attachment surface 105 in order to prevent movement of the linear element 100. The depth of the driven staple 30 is controlled by the action of the inner plunger 20 (as shown in FIG. 1) within the outer tube 15 (as shown in FIG. 1) and as controlled by the depth adjustment nut 55 (as shown in FIG. 1).

The preferred embodiment of the present invention can be utilized by the common user in a simple and effortless manner with little or no training. It is envisioned that the device 10 would be constructed in general accordance with FIG. 1 through FIG. 3.

After procurement or construction of a device 10 in accordance with the aforementioned teachings, the device 10 would be initially used as follows: The user 80 would loosen the connecting fastener 35 in the threaded opening 40; allowing the inner plunger 20 to move freely within the outer tube 15; insert a staple 30 into the flared portion 25; straddle the staple 30 over a linear element 100, carefully and slowly pound the domed top 45 until the staple 30 is at the correct depth; move the rubber “O” ring 60 down to contact the proximal end of the outer tube 15, turn the depth adjustment nut 55 until it contacts the rubber “O” ring 60. At this point in time, the device 10 may be removed from the staple 30 whereupon it is ready to use in a repeated fashion on additional staple 30.

During use on additional staple 30, the following process is utilized. The user 80 would insert a staple 30 into the flared portion 25; straddle the staple 30 over a linear element 100, tap and then pound the domed top 45 until the rubber “O” ring 60 and depth adjustment nut 55 contact the proximal end of the outer tube 15, whereupon the staple 30 is automatically set to the proper depth as previously adjusted. The process may continue with additional staple 30 as required in a cyclical process.

When finished with use the user would tighten the connecting fastener 35 in the threaded opening 40 thus impinging the inner plunger 20 within the outer tube 15 and preventing unwanted separation and movement during transport or storage of the device 10.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A staple installation tool comprising:
an outer tube comprising:
an outer tube first end;
an outer tube second end;
an inner void running from said outer tube first end to said outer tube second end;
a flared portion disposed at said outer tube first end;
a threaded portion disposed at said outer tube second end;
an aperture disposed upon an exterior surface of said outer tube; and,
a fastener configured to secure within said aperture;
wherein said flared portion defines an interior configured to removeably secure a staple therein;
an inner plunger having a threaded outer surface comprising:
an inner plunger first end;
an inner plunger second end;
a domed top secured to said inner plunger second end; and, a depth adjustment nut configured to threadingly engage said threaded outer surface adjacent said domed top;
wherein a diameter of said inner void is greater than a diameter of said inner plunger; and,
wherein when said inner plunger is inserted into said outer tube second end having said staple removeably inserted into said flared portion, a first force applied to said domed top is transferred through said inner plunger into a head of said staple thereby driving said point sides of said staple into a surface.

2. The tool of claim 1, wherein said inner plunger further comprises:
a first flattened area disposed at said inner plunger first end; and,
a second flattened area disposed adjacent said inner plunger second end;
wherein said first flattened region is configured to engage said head of said staple;
wherein said second flattened region is configured to selectively engage a distal end of said fastener; and,
wherein when inserted into said aperture, said distal end of said fastener limits a range of movement of said plunger within said outer tube.

3. The tool of claim 1, wherein said fastener comprises a wing bolt.

4. The tool of claim 1, wherein said depth adjustment nut is greater than an outer diameter of said outer tube.

5. The tool of claim 1, wherein said outer tube comprises a length of no more than seven and one-half inches.

6. The tool of claim 5, wherein said inner void comprises a diameter of no more than one-half an inch.

7. The tool of claim 1, wherein said flared portion comprises a length of no more than one and one-half inches.

8. The tool of claim 7, wherein said flared portion comprises an outer width of no more than seven-eighths of an inch.

9. The tool of claim 8, wherein said flared portion comprises an inner width of no more than eleven sixteenths of an inch.

10. The tool of claim 1, further comprising a cap configured to threadingly secure about said outer tube second end.

11. A staple installation tool comprising:
an outer tube comprising:
an outer tube first end;
an outer tube second end;
an inner void running from said outer tube first end to said outer tube second end;
a flared portion disposed at said outer tube first end;
a threaded portion disposed at said outer tube second end;
an aperture disposed upon an exterior surface of said outer tube; and,
a fastener configured to secure within said aperture;
wherein said flared portion defines an interior configured to removeably secure a staple, therein;
an inner plunger having a threaded outer surface comprising:
an inner plunger first end;
an inner plunger second end;
a domed top secured to said inner plunger second end;
a depth adjustment nut configured to threadingly engage said threaded outer surface adjacent said domed top; and,
an O-ring secured about said threaded outer surface adjacent said depth adjustment nut opposite said domed top;
wherein a diameter of said outer tube void is greater than a diameter of said inner plunger; and,
wherein when said inner plunger is inserted into said outer tube second end having said staple removeably inserted into said flared portion, a first force applied to said domed top is transferred through said inner plunger into a head of said staple thereby driving said point sides of said staple into a surface.

12. The tool of claim 11, wherein said inner plunger further comprises:
a first flattened area disposed at said inner plunger first end; and,
a second flattened area disposed adjacent said inner plunger second end;
wherein said first flattened region is configured to engage said head of said staple;
wherein said second flattened region is configured to selectively engage a distal end of said fastener; and,
wherein when inserted into said aperture, said distal end of said fastener limits a range of movement of said plunger within said outer tube.

13. The tool of claim 11, wherein said fastener comprises a wing bolt.

14. The tool of claim 11, wherein said depth adjustment nut is greater than an outer diameter of said outer tube.

15. The tool of claim 11, wherein said outer tube comprises a length of no more than seven and one-half inches.

16. The tool of claim 15, wherein said inner cylindrical void comprises a diameter of no more than one-half an inch.

17. The tool of claim 11, wherein said flared portion comprises a length of no more than one and one-half inches.

18. The tool of claim 17, wherein said flared portion comprises an outer width of no more than seven-eighths of an inch.

19. The tool of claim 18, wherein said flared portion comprises an inner width of no more than eleven sixteenths of an inch.

20. The tool of claim 11, further comprising a cap configured to threadingly secure about said outer tube second end.
